(19) United States
(12) Patent Application Publication
(10) Pub. No.: US 2023/0200411 A1
(43) Pub. Date: Jun. 29, 2023

(54) LONG LASTING EDIBLE CHEW

(71) Applicant: Archer Daniels Midland Company, Decatur, IL (US)

(72) Inventors: Jolene Hoke, Bethany, IL (US); Jason Meyer, Sabetha, KS (US); Robert Niehues, Decatur, IL (US); Rocklyn Stucky, Sabetha, KS (US); Paul Tedman, Sabetha, KS (US)

(21) Appl. No.: 17/996,902

(22) PCT Filed: Apr. 22, 2021
(86) PCT No.: PCT/US2021/028620

§ 371 Date: Oct. 21, 2022

Related U.S. Application Data
(60) Provisional application No. 63/014,563, filed on Apr. 23, 2020.

(51) Int. Cl. A23K 20/147; A23K 20/163; A23K 50/40; A23K 20/20

(52) U.S. Cl. CPC A23K 20/147; A23K 20/163; A23K 50/40; A23K 20/20

(57) ABSTRACT

Long lasting edible pet chews are disclosed. Processes of producing such pet chews are further disclosed.

### TECHNICAL FIELD

The present invention relates generally to animal feeds and more particularly, to a pet chew.

### BACKGROUND OF THE INVENTION

There are a number of pet treats made with agricultural processing by-products on the market. Many of these are made by extrusion, extrusion plus molding and forming, or injection molding. However, some of these pet treats have difficulty dissolving in the stomach of the pets.

There are also pet treats made from animal co-products. An example is a raw hide chew type product which can be made by drying and forming. One disadvantage of such raw hide type chews is that large pieces of such raw hide have the ability to get impacted in the intestine of a dog that swallows such large piece.

In each of its various embodiment, the present invention overcomes the disadvantages of the prior art pet chews.

### SUMMARY OF THE INVENTION

In each of its various embodiments, the present invention fulfills these needs and discloses improved pet treats.

In one embodiment, a composition configured as a pet chew, comprises a plant-based starch, a plant-based fiber, and a plant-based protein. The composition comprises about 5-15% crude protein and 5-15% crude fiber. The composition further substantially breaks down in an animal's digestive system after a period of 24 hours.

In another embodiment, a composition configured as a pet chew has a first portion and second portion. The first portion and the second portion are physically distinct pieces and interlocked.

In a further embodiment, a process of forming a pet chew includes mixing an ingredient selected from the group consisting of a plant based starch, a plant based protein, a plant based fiber, and combinations of any thereof with a liquid plasticizer, thus producing a mixture. The mixture is extruded through a die having at least two physically separated openings, thus producing at least two physically separated extrudates. The at least two physically separated openings are configured to interlock the at least two physically separated extrudates as the at least two physically separated extrudates exit the die during extrusion.

In an additional embodiment, a process of forming a pet chew comprises mixing an ingredient selected from the group consisting of a plant based starch, a plant based protein, a plant based fiber, and combinations of any thereof with a liquid plasticizer, thus producing a mixture. The mixture is extruded through a first die configured to extrude at least two physically separated extrudates. The at least two physically separated extrudates are passed through an opening situated in relation to the first die such that as the at least two physically separated extrudates pass through the first die and the opening, at least a portion of one of the at least two physically separated extrudates presses against at least a portion of another of the at least two physically separated extrudates that are interlocked as the at least two physically separated extrudates exit the first die.

In a further embodiment, a process of forming a rawhide free pet chew comprises mixing an ingredient selected from the group consisting of a starch, a protein, a fiber, and combinations of any thereof with a liquid plasticizer, thus producing a mixture, subjecting the mixture to pressure, an elevated temperature, or a combination thereof, and a step for forming the mixture to resemble a rolled rawhide chew.

### BRIEF DESCRIPTION OF THE DRAWINGS

FIG. 1 depicts one embodiment of a die used to produce a pet chew of the present invention.

FIGS. 2A and 2B illustrate the separate openings of the die of FIG. 1.

FIG. 3 shows a perspective view of one embodiment of pet chews produced according to the present invention.

FIG. 4 illustrates one embodiment of an arrangement of a die and an opening used to produce the pet chews of the present invention.

FIG. 5 depicts a front view of one embodiment of a pet chew of the present invention as the pet chew exits a die and enters an opening.

FIG. 6 illustrates an end view of one embodiment of a pet chew of the present invention.

### DETAILED DESCRIPTION OF THE INVENTION

In one embodiment, a composition configured as a pet chew, comprises a plant-based starch, a plant-based fiber, and a plant-based protein. The composition comprises about 5-15% crude protein and 5-15% crude fiber. The composition substantially breaks down in an animal's digestive system after a period of 24 hours.

The composition may be substantially free of animal-based ingredients.

At least one of the plant-based starch and the plant-based fiber of the composition may be of a pea origin.

The plant-based starch may have a characteristic selected from the group consisting of a moisture content of at most about 10% by weight, a protein content of greater than about 10% based on dry matter, a starch content of greater than about 65% based on dry matter, a particle size through a 100 mesh of greater than about 90%, an origin of coming from yellow peas, and combinations of any thereof.

The plant based fiber may have a characteristic selected from the group consisting of a moisture content of at most about 10% by weight, a protein content of at least about 5% based on dry matter, a fat content of at most about 1% based on dry matter, an ash content of at most about 3% based on dry matter, a fiber content of at least about 45% based on dry matter, a fiber content of between about 45% and about 65% based on dry matter, a particle size through a US 80 sieve of about 100%, an origin coming from yellow peas, and combinations of any thereof.

In a further embodiment, a composition configured as a pet chew includes a first portion and second portion that are physically distinct pieces. The first portion and the second portion are also interlocked.

The pet chew may substantially break down in an animal's digestive system after a period of 24 hours. The composition may include about 5-15% crude protein and 5-15% crude fiber. The composition may include an ingredient selected from the group consisting of a plant-based starch, a plant-based fiber, a plant-based protein, and combinations of any thereof. At least one of the plant-based starch and the plant-based fiber may be of a pea origin.

In a further embodiment, a process of forming a pet chew comprises mixing an ingredient selected from the group consisting of a plant-based starch, a plant based protein, a plant based fiber, and combinations of any thereof with a liquid plasticizer, thus producing a mixture. The process also comprises extruding the mixture through a die having at least two physically separated openings, thus producing at least two physically separated extrudates, wherein the at least two physically separated openings are configured to extrude the at least two physically separated extrudates that are interlocked as the at least two physically separated extrudates exit the die.

The at least two physically separated openings have a coil shape that coils at least 270° such that the at least two physically separated extrudates are interlocked. In another embodiment, the at least two physically separated openings have a coil shape that coils at least 360° such that the at least two physically separated extrudates are interlocked.

The process may further include passing the at least two physically separated extrudates through an opening situated in relation to the die such that as the at least two physically separated extrudates pass through the die and the opening, at least a portion of one of the at least two physically separated extrudates presses against at least a portion of another of the at least two physically separated extrudates that are interlocked as the at least two physically separated extrudates exit the die.

The die may be cone shaped.

In another embodiment, a process of forming a pet chew comprises mixing an ingredient selected from the group consisting of a plant-based starch, a plant based protein, a plant based fiber, and combinations of any thereof with a liquid plasticizer, thus producing a mixture. The process also comprises extruding the mixture through a first die configured to extrude at least two physically separated extrudates. The process further comprises passing the at least two physically separated extrudates through an opening situated in relation to the first die such that as the at least two physically separated extrudates pass through the first die and the opening, at least a portion of one of the at least two physically separated extrudates presses against at least a portion of another of the at least two physically separated extrudates that are interlocked as the at least two physically separated extrudates exit the first die.

The opening is tapered such that a first dimension of the opening receiving the at least two physically separated extrudates is larger than a second dimension of the opening where the at least two physically separated extrudates exit the opening. The opening may be a second die and the first die may be cone shaped. A tip of the cone of the first die may be positioned at least partially inside the opening.

A product produced by the process of any of the processes discloses herein is also contemplated. The product may comprise the composition of any of the embodiments disclosed herein.

In an embodiment, the present invention is directed towards a pet chew that is durable enough to be chewed by a pet yet is dissolvable enough that when the pet consumes the chew, the chew dissolves in the pet's stomach and small intestine.

In one embodiment, the pet chew of the present invention is free from any animal products such as rawhide.

In other embodiments, the pet chew of the present invention has low odor and is 100% dissolvable in the digestive system of the pet.

In a further embodiment, the pet chew is a long-lasting chew for a dog that is durable enough so that the pet chew can be chewed for at least 5 minutes or even at least 10 minutes.

In an additional embodiment, the pet chew provides oral care and plaque reduction benefits to the pet that chews the pet chew.

In one embodiment of the present invention, a method that correlates physio-chemical properties of pet chews with in vitro dissolvability that mimic the digestive system of a pet is used to assess the dissolvability of the pet chew.

Two formulations were used to prepare pet chews of the present invention. The ingredients of the two formulations are shown in Table 1.

TABLE 1

| | Formulation 1, | Formulation 2, |
|---|---|---|
| Ingredient | percent by weight | percent by weight |
| Pea starch | 25.35% | 24.62% |
| Paygel 290 brand wheat | 15.73% | 15.28% |
| starch | | |
| Arcon AF brand soy | 7.25% | 7.04% |
| protein concentrate | | |
| glycerin | 8.97% | 8.71% |
| water | 8.97% | 11.61% |
| Corn syrup | 5.83% | 5.66% |
| Pea fiber | 16.48% | 16.00% |
| gelatin | 0 | 1.51% |
| Guar gum | 3.11% | 1.51% |
| cellulose | 3.11% | 3.02% |
| Canola oil | 1.49% | 1.45% |
| salt | 1.04% | 1.01% |
| Palatant AFB 6C2AQ | 0.82% | 0.80% |
| lecithin | 1.04% | 1.01% |
| Potassium sorbate | 0.31% | 0.30% |
| Citric acid | 0.52% | 0.50% |

The ingredients of Table 1 were mixed, ground, and classified. The mixed ingredients were placed in an extruder, such as a twin or single screw extruder. After being extruded through a die, the extruded chews were placed on a belt conveyer, cut, cooled, and packaged.

In an embodiment, the pea starch has a moisture content of at most about 10% by weight, a protein content of at least about 5% based on dry matter, a fat content of at most about 1% based on dry matter, an ash content of at most about 3% based on dry matter, a fiber content of at least about 45% based on dry matter, a fiber content of between about 45% and about 65% based on dry matter, a particle size through a US 80 sieve of about 100%, and an origin coming from yellow peas.

In an embodiment, the pea fiber has a moisture content of at most about 10% by weight, a protein content of at least about 5% based on dry matter, a fat content of at most about 1% based on dry matter, an ash content of at most about 3% based on dry matter, a fiber content of at least about 45% based on dry matter, a fiber content of between about 45% and about 65% based on dry matter, a particle size through a US 80 sieve of about 100%, and an origin coming from yellow peas.

In one embodiment, a Clextral extruder was used. The extruder setup was as follows: a feeder RPM of between about 20-25; a dry feed rate of about 650-800 lbs/hour; a water to CC rate of about 90-110 lbs/hour; a water to barrel rate of about 15-19 lbs/hour; an extruder RPM of about 250-310; the extruder amps were about 31-37 Amps; the preconditioner temperature was about 190-230° F.; the die adaptor temperature was about 200-250° F.; head 3 and head were both heated; the inlet head temperature was ambient; the micro motion settings were about 130-160 lbs/hour; the parastolic pump settings were about 13-15 lbs/hour; the dryer temperature was ambient; the top bed speed was about 18-22 minutes; the bottom bed speed was about 26-44 minutes; cooler circulation fans were used; the 525 cold former was about 72-88 Hz; and the knife RPM was an ESI cutter or a guillotine cutter.

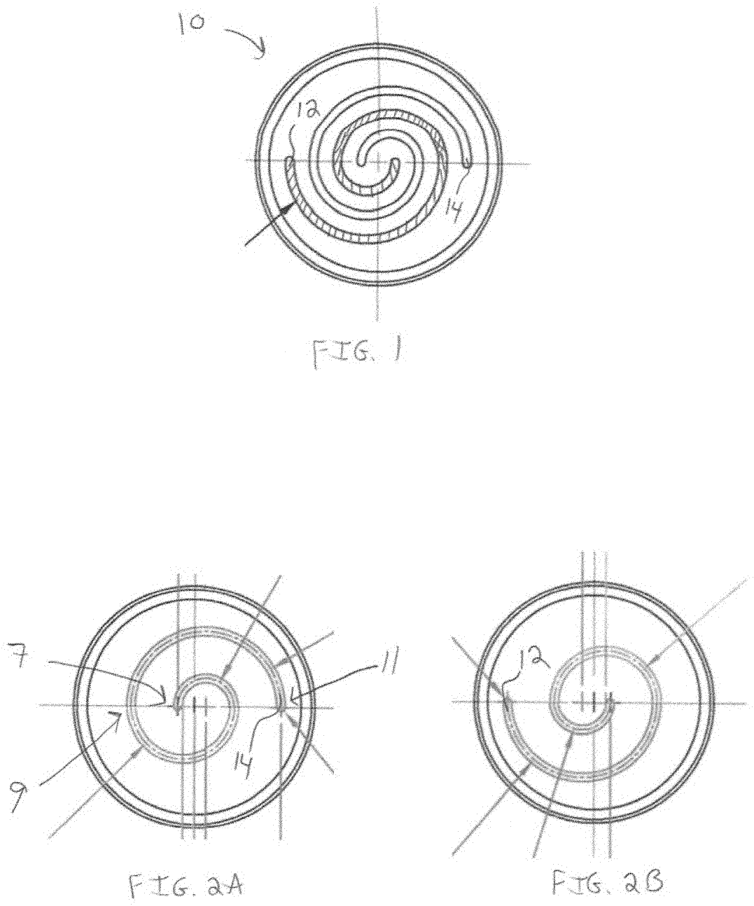

The die of the extruder was designed such that upon being extruded, the pet chew has an increased surface area. FIG. 1 shows one embodiment of a die used to produce the pet chew of the present invention generally at 10. The die 10 includes two physically separated openings, 12 that is (for illustrative purposes) shaded and 14 that is clear. In this embodiment, the two openings 12 and 14 have a generally curved/twisted shape such that upon extrusion of a pet chew through the die 10, two physically separated extrudates exit the die 10. The two physically separated extrudates are physically interlocked as they exit the die 10. The design of the die 10 is this manner allows the pet chew to resemble a folded pet chew, but no post extrusion processing or folding is required. FIGS. 2A and 2B show the two physically separated openings 14 and 12, respectively, of the die 10.

Referring to FIG. 2A, the physically separated opening is design to have a general coil or twisting shape. As shown in two dimensions, the coil shape starts at arrow 7 and coils 360° around to arrow 9 and continues around and ends at arrow 11 for a total of 540°. The coiled shape of the two physically separated openings 12 and 14 enables the two extrudates that form pet chew to be interlocked. In one embodiment, the coiled shape is at least 360° in order for the two extrudates to be interlocked.

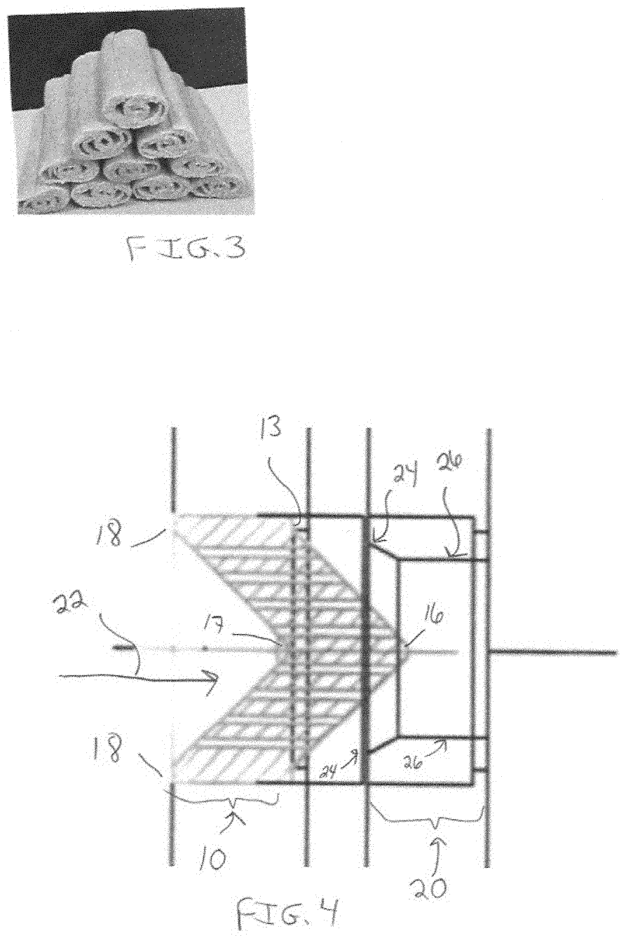

The design of the die 10 allows the pet chew of the present invention to have a larger surface area as compared to most conventional pet chews. The design of the die 10 also allows the pet chew of the present invention to resemble a folded conventional raw hide chew. FIG. 3 shows one embodiment of a perspective view of the pet chew produced with the die 10 of FIG. 1.

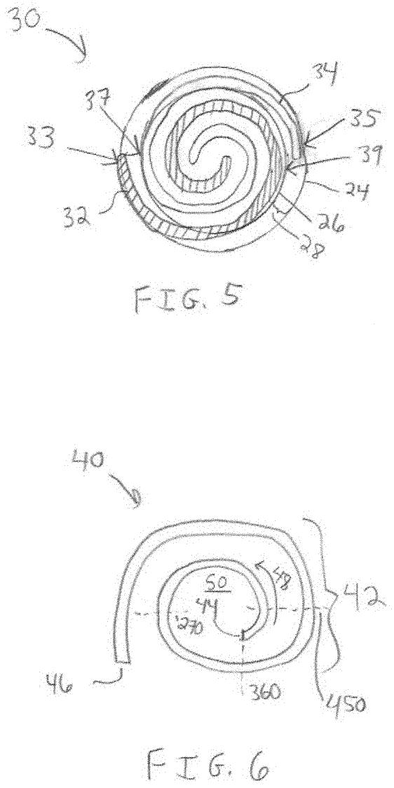

FIG. 4 shows a cross-sectional view of an embodiment of the die 10 used to produce the pet chew of the present invention. In this embodiment, the die 10 is situated in relation to a second die 20 that is in essence a circular opening. The die 10 is cone shaped in that a first surface 16 of the center of the die 10 protrudes from one edge 13 of the die 10 and that a second surface 17 of the center of the die 10 protrudes from a second edge 18 of the die.

As a pet chew (not illustrated) of the present invention is extruded through the die 10 in a direction as shown by arrow 22, the pet chew passes through the second die 20. The second die 20 is designed such that an opening shown by arrows 24 of the second die 20 is larger on the side facing the die 10, and the opening of the second die 20 tapers to a smaller opening shown by arrows 26. As the two physically separated extrudates of the pet chew pass through the openings 24 and 26 of the second die 20, a portion of one of the two physically separated extrudates is pressed against a portion of the second of the two physically separated extrudates by the narrowing of the two openings 24 and 26 of the second die 20. The two openings 24 and 26 of the second die are tapered such that the two physically separated extrudates are compressed.

FIG. 5 shows a front view of a pet chew 30 of the present invention as the pet chew 30 is extruded and exits the die 10 of FIG. 4. A first extrudate 32 and a second extrudate 34 are shown. Two concentric circles are drawn which show the larger opening 24 and the smaller opening 26 of the second die 20 of FIG. 4. Space 28 shows the taper between the larger opening 24 and the smaller opening 26. As the pet chew 30 leaves the die 10 and enters the second die 20, the taper 28 forces an end 33 of the first extrudate 32 to compress and be pressed against a portion 37 of the second extrudate 34. The taper 28 also forces an end 35 of the second extrudate 34 to compress and be pressed against a portion 39 of the first extrudate 32. In this manner, the compressed ends of the pet chew 10 do not flare out as the pet chew 10 dries and helps give the pet chew 10 the appearance of a folded raw hide chew as illustrated in FIG. 3.

The 2 formulations of this Example have the following amounts, by weight percent: about 41.09% starch; about 7.25% protein; about 19.58% fiber; about 1.49% fat; about 5.83% humectant; about 8.97% plasticizer; and about 8.97% water.

The 2 formulations of this Example have the nutritional panel information shown in Table 2, by weight percent.

TABLE 2

| Formulation | Moisture | Protein | Fat | Crude Fiber | Ash |
|---|---|---|---|---|---|
| 1 | 9.4% | 8.8% | 1.9% | 8.7% | 2.77% |
| 2 | 9.5% | 10% | 1.6% | 8.9% | 2.75% |

The pet chews of this Example were stored for 12 weeks in a climate-controlled room and various parameters were measured. The pet chews lost moisture during the first 3 weeks of storage and the moisture stabilized after about 3 weeks. A dynamic mechanical analysis was also performed and it was determined that the pet chews got harder and the glass transition point increased over time, probably due to the moisture leaving the pet chews.

The pet chews were also evaluated to in vitro dissolution to determine the dry matter disappearance.

A texture analysis was also done on the pet chews to determine the bit force and gut force required to break the pet chew

The pet chew of Formulation 2 was also subjected to in vivo evaluation in English pointers to assess the chew time and stool quality assessment. The evaluations were performed using known procedures. The average chew time for the pet chews of Formulation 2 were on Day 1, 10.3 minutes; Day 2, 10.0 minutes; and Day 3, 10.0 minutes. The range of chew times for the pet chews of Formulation 2 were on Day 1, 8-12 minutes; Day 2, 7.75-12 minutes; and Day 3, 7.5-11.25 minutes. Stool quality assessments were also done for the pet chews of Formulation 2. The stool quality average was 3.57 with 3 being soft and 4 being normal. The range was 3-4 on all samples evaluated. The color of the stool was acceptable of medium-dark brown. 7 out of 10 dogs transitioned from medium brown to dark brown stool by the end of day 3 of the supplementation.

FIG. 6 shows an end view of another embodiment of a pet chew of the present invention generally at 40. In this view, the pet chew 40 has a design that mimics or resembles a convention rawhide pet chew. The process for producing the pet chew 40 includes mixing a starch, a protein, and a fiber as described herein with a liquid plasticizer to produce a mixture. The mixture may be subjected to an elevated temperature and/or heat.

The pet chew 40 is formed with a step for forming the mixture to resemble a rolled rawhide chew, such as those commercially available. The step for forming the mixture to resemble a rolled rawhide chew has the benefit of being a continuous process that does not require the need of manual rolling of the pet chew 40 of the present invention. This enables the pet chew 40 of the present invention to be formed with a continuous extrusion process, with the need for any post extrusion processing. The pet chew 40 is ready to be packaged after the pet chew 40 exits an extruder. The pet chew 40 is extruded through a die substantially as described herein, wherein the die has a general spiral shape as indicated with bracket 42 in FIG. 6. The die that forms the pet chew 40 produces a pet chew 40 with a first end 44 and a second end 46. The die is configured such that the pet chew 40 has the general spiral shape, where the opening of the die enables the pet chew to have the spiral shape that coils at least about 270 degrees indicated by arrow 48, at least about 360 degrees, at least about 450 degrees, or even more as shown in the spiral of FIG. 6.

It will be appreciated by those of ordinary skill in the art that while the pet chew 40 having the general spiral shape is depicted with a spiral having generally circular curves, the general spiral shape could also be achieved with a plurality of straight lines, lines and curves, or other geometric shapes in order to form the mixture to resemble a rolled rawhide chew.

The “rolled” pet chew 40 has an opening or space 50 formed by the general spiral shape. This opening 50 could be filled in with any type of desired feed ingredient including, but not limited to, a flavored substance to make the pet chew 40 more appealing to an animal, a nutritional ingredient to provide more protein, fiber or other desired nutritional ingredient, or any other desired feed ingredient. The opening 50 could include some type of oral health care product that could be used, for example, to reduce dental plaques in an animal that consumes the pet chew 40.

This disclosure has been described with reference to certain exemplary embodiments, compositions, and uses thereof. However, it will be recognized by those of ordinary skill in the art that various substitutions, modifications, or combinations of any of the exemplary embodiments may be made without departing from the spirit and scope of the disclosure. Thus, the disclosure is not limited by the description of the exemplary embodiments, but rather by the appended claims as originally filed.

1-15. (canceled)

16. A process of forming a pet chew, the process comprising:
mixing an ingredient selected from the group consisting of a starch, a protein, a fiber, and combinations of any thereof with a liquid plasticizer, thus producing a mixture; and
extruding the mixture through a die having at least two physically separated openings, thus producing at least two physically separated extrudates, wherein the at least two physically separated openings are configured to interlock the at least two physically separated extrudates as the at least two physically separated extrudates exit the die.

17. (canceled)

18. The process of claim 16, wherein at least one of the at least two physically separated openings has a coil shape that coils at least 270°.

19. The process of claim 16, wherein at least one of the at least two physically separated openings has a coil shape that coils at least 360°.

20. The process of claim 16, further comprising passing the at least two physically separated extrudates through an opening situated in relation to the die such that as the at least two physically separated extrudates pass through the die and the opening, at least a portion of one of the at least two physically separated extrudates presses against at least a portion of another of the at least two physically separated extrudates that are interlocked as the at least two physically separated extrudates exit the die.

21. The process of claim 16, wherein the die is cone shaped.

22-24. (canceled)

25. A process of forming a pet chew, the process comprising:
mixing an ingredient selected from the group consisting of a starch, a protein, a fiber, and combinations of any thereof with a liquid plasticizer, thus producing a mixture;
extruding the mixture through a first die configured to extrude at least two physically separated extrudates; and
passing the at least two physically separated extrudates through an opening situated in relation to the first die such that as the at least two physically separated extrudates pass through the first die and the opening, at least a portion of one of the at least two physically separated extrudates presses against at least a portion of another of the at least two physically separated extrudates as the at least two physically separated extrudates exit the first die.

26. The process of claim 25, wherein the opening is tapered such that a first dimension of the opening receiving the at least two physically separated extrudates is larger than a second dimension of the opening where the at least two physically separated extrudates exit the opening.

27. The process of claim 25, wherein the opening is a second die.

28. The process of claim 25, wherein the first die is cone shaped.

29. The process of claim 28, wherein a tip of the cone of the first die is positioned at least partially inside the opening.

30. The process of claim 25, wherein the at least two physically separated openings are configured to interlock the at least two physically separated extrudates as the at least two physically separated extrudates exit the first die.

31-33. (canceled)

34. The process of claim 25, wherein the mixture comprise:
the starch;
the fiber; and
the protein;
wherein the mixture comprises about 5-15% crude protein and 5-15% crude fiber;
wherein the mixture substantially breaks down in an animal's digestive system after a period of 24 hours.

35. A process of forming a rawhide free pet chew, the process comprising:
mixing an ingredient selected from the group consisting of a starch, a protein, a fiber, and combinations of any thereof with a liquid plasticizer, thus producing a mixture;
subjecting the mixture to pressure, an elevated temperature, or a combination thereof; and
step for forming the mixture to resemble a rolled rawhide chew.

36. The process of claim 35, wherein the step for forming the mixture to resemble the rolled rawhide chew comprises extruding the mixture through a die with at least one opening having a general spiral shape.

37. The process of claim 36, wherein the at least one opening of the general spiral shape has a first end and second end, wherein the first end and the second end are positioned such that the general spiral shape coils at least 270 degrees.

38. The process of claim 36, wherein the first end and the second end are positioned such that the general spiral shape coils at least 360 degrees.

39. The process of claim 36, wherein the first end and the second end are positioned such that the general spiral shape coils at least 450 degrees.

40. The process of claim 35, further comprising incorporating a feed ingredient into an opening in the mixture formed to resemble the rolled rawhide chew.

41. The process of claim 40, wherein the feed ingredient is an oral health care product, a flavored composition, a protein, or other feed ingredient.

42. The process of claim 35, wherein the process is continuous.

43. (canceled)
